(19) United States
(12) Patent Application Publication
(10) Pub. No.: US 2002/0000972 A1
(43) Pub. Date: Jan. 3, 2002

(54) Pointer coordinates assignment

(76) Inventors: Arnoldus Johannes Juliana Boudewijns, Eindhoven (NL); Hendrikus Antonlus Andreas Van Den Berg, Eindhoven (NL)

Correspondence Address: Michael E. Marion, c/o PHILIPS ELECTRONICS NORTH AMERICA CORPORATION, Corporate Intellectual Property, 580 White Plains Road, Tarrytown, NY, 10591, US

(21) Appl. No.: 09/747,110

(22) Filed: Dec. 21, 2000

(30) Foreign Application Priority Data
Dec. 22, 1999 (EP) 99204474.3

(51) Int. Cl. G09G 5/08

(52) U.S. Cl. 345/157

(57) ABSTRACT

The invention relates to an information processing device, i.e. a computer, connectable to a displacement signal generating device, i.e. a mouse, which information processing device comprises a memory and means for storing pointer coordinates in the memory on a first-in first-out basis. Means are present for assigning pointer coordinates to the computer as a function of pointer coordinates in the memory upon clicking of a mouse button.

The invention relates to an information processing device connectable to a displacement signal generating device.

Information processing devices appear in various forms. The best known is a personal computer or PC. And even that one is known in different variations from desktop models to laptops. Other information processing devices are e.g. set-top boxes, web TV and other devices and control parts of other devices. Hereinafter all those forms of information processing devices will be referred to as computers.

Displacement signal generating devices are known in various forms. The best known is a mouse. Other forms are known as e.g. a trackball or a pad. Hereinafter all those forms of displacement signal generating devices will be referred to by the word mouse.

When a person using a mouse wants to click a particular point on a screen of a monitor of the computer he or she normally carries out the following actions. Firstly, the mouse is moved in such a way that a pointer, usually an arrow, points to a desired position on the screen. Coordinates of the position of the pointer on the screen are referred to hereinafter as pointer coordinates. Secondly, the mouse is not moved anymore. Thirdly, the user presses a mouse button with a finger (and possibly releases the button). Fourthly, the mouse is moved in such a way that the pointer moves away from that position.

The problem starts when the user has to press the mouse button. At that instant the user has difficulty keeping the pointer at the same position on the screen. Since normally pointer coordinates assigned to the computer are sampled at the instant that the user clicks the button it is important for the mouse not to be moved between the instant that visually the user registers that the mouse is at the correct position and the instant that the muscles in the finger, and not in the hand, are controlled to operate the mouse button.

By clicking a mouse button pointer coordinates are assigned to the computer. Some people experience difficulties in holding the mouse still while clicking a mouse button. Especially when the user wants to place a graphics object on the screen, an accuracy equal to a screen pixel may be needed. Often the user attempts to place a graphics object a few times before it is correctly placed on the screen. This can be very annoying and time consuming for the user. A solution often used for this problem is to zoom in on the object to be placed in order to position it accurately. However, repetitively zooming in and out is not convenient for the user.

Japanese Laid-Open Patent Application 07 230355 shows a mouse in which, to prevent erroneous input, a mouse main body is provided with a ball lock mechanism which locks the ball of the mouse for movement. The ball lock mechanism is operated by a further element on the mouse and has to be operated by a further finger of the person holding the mouse. This contributes to the difficulties experienced by the user.

It is an object of the present invention to provide a computer connectable to a mouse that does not have the above mentioned disadvantages.

In order to achieve this object, an information processing device connectable to a displacement signal generating device is characterized in that a memory is present, in that means are present for storing pointer coordinates in the memory on a first-in first-out basis, and in that means are present for, upon clicking of a mouse button, assigning to the computer pointer coordinates as a function of pointer coordinates in the memory.

A preferred embodiment of an information processing device according to the invention is characterized in that the function enables pointer coordinates that have been present in the memory for the longest period of time to be assigned to the information processing device.

Thus, it is achieved that a certain delay is built into the computer, as a result of which the coordinates assigned to the computer by a click of a mouse button are not the pointer coordinates at the exact instant at which the mouse button is actually operated but at a slightly earlier instant. Thus, it is achieved that any erroneous movement, due to unwanted hand movements between the instant that the brain of the user has registered the correct positioning of the mouse and the instant of actuation of the mouse button by the hand, is ignored.

A further preferred embodiment of an information processing device according to the invention is characterized in that the function enables pointer coordinates to be assigned to the information processing device, which pointer coordinates are an average of certain pointer coordinates inputted into the memory during a first predetermined period of time before clicking and during a second predetermined period of time after clicking.

In this embodiment is is assumed that an average position of the mouse, which is the average of positions taken up by the mouse during time periods just before and just after a click of the mouse button, coincides with the desired position at which the user wanted to click the mouse button.

A further preferred embodiment of an information processing device according to the invention is characterized in that the second period of time is zero and in that the function enables pointer coordinates that are an average of certain pointer coordinates present in the memory at the instant of clicking to be assigned to the information processing device.

Thus, it is achieved that a group of stored pointer coordinates can be used to calculate an average pointer position, which is based on the assumption that pointer coordinates carry the largest weight especially before clicking. Thus, it is also achieved that slight movements of the mouse in the period before the actual click takes place do not play a significant role in assigning pointer coordinates to the computer, because such slight movements may be assumed to cancel each other to a large degree or completely.

The invention will now be described in more detail with reference to the accompanying drawings, in which:

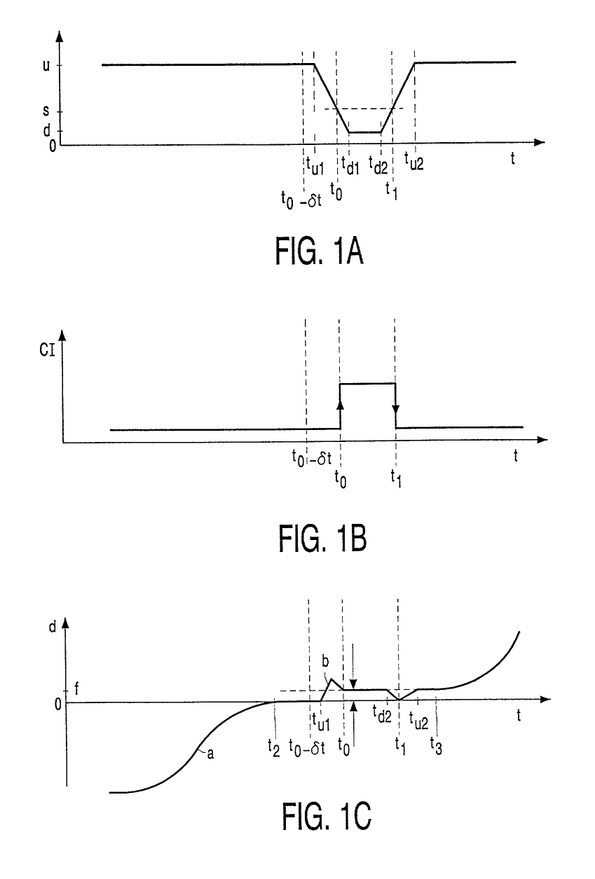

FIG. 1A shows the travel distance of a mouse button and the switching level at which a signal is generated to operate a computer in order to determine pointer coordinates;

FIG. 1B shows the signal that triggers the computer to assign pointer coordinates;

FIG. 1C shows how an error in the pointer coordinates assigned to a computer comes about;

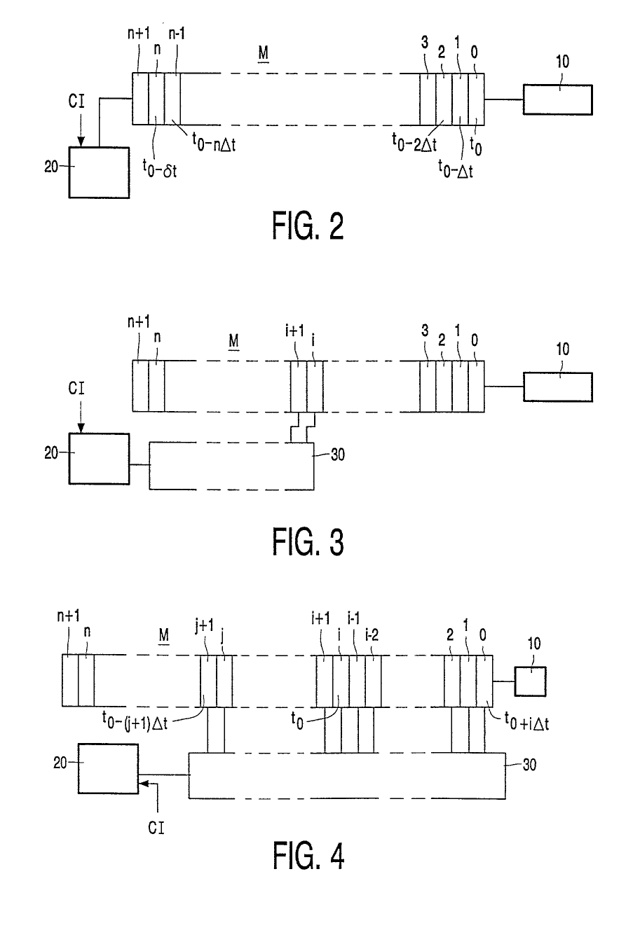

FIG. 2 shows a memory used in a first embodiment according to the present invention;

FIG. 3 shows a memory used in a second embodiment according to the present invention; and

FIG. 4 shows a memory used in a third embodiment according to the present invention.

FIG. 1A illustrates the normal operation of clicking a mouse button. In particular, it shows the distance of travel of a mouse button between a level u at which it is not depressed at all and a level d at which it is fully depressed. At an instant tᵤ₁ a user starts to press down the mouse button and at an instant t_{d1} the mouse button is fully depressed by the user. Subsequently, the mouse button remains in the fully depressed state for a certain period of time and an instant t_{d2} the user starts to release the mouse button. At an instant tᵤ₂ the mouse button is again back in its uppermost position. The level s at which a signal is generated for inputting into the computer is somewhere between the levels u and d. As shown in FIG. 1A, the level s is reached when going from the level u to the level d at an instant to and the level s is reached again when going up from the level d to the level u at an instant t₁.

FIG. 1B shows that a signal is input into the computer, starting at the instant to and ending at the instant t₁. As is well known, the signal CI shown in FIG. 1B triggers the computer to assign pointer coordinates as generated at that particular instant to.

FIG. 1C shows a distance d between actual pointer coordinates and a zero position in which the pointer coordinates coincide with desired pointer coordinates. A curve a in FIG. 1C shows how a user operates the mouse to reach desired pointer coordinates. Desired pointer coordinates are reached at an instant t₂. Subsequently, the user clicks a mouse button and al an instant t₃ the operation of clicking a mouse button has ended and the user travels further with the mouse, away from the desired screen position.

In theory the pointer coordinates should remain at desired pointer coordinate d, which is zero from the instant t₂ to the instant t₃. In practice, it is not easy to accomplish such a result. As shown in FIG. 1C, at the instant tᵤ₁, when a finger of an user starts to press down the mouse button other muscles in the hand of the user start to move the mouse around as shown by a curve b. The curve b can be any kind of curve, but usually it is erratic. Usually the curve b is not at the “zero” position at the instant to when the mouse button being pressed down crosses the switching level s, but at a distance f from the desired screen coordinate. As a consequence, pointer coordinates corresponding to the distance f from the desired screen position are assigned to the computer at the instant to. For completeness, the reverse operation from an instant td2 to the instant t₃ is also shown in FIG. 1C, a though it is less relevant to the present invention.

FIG. 2 shows a memory present in the computer, for storing actual pointer coordinates. Each time that a period of time Δt has elapsed actual pointer coordinates at that instant are assigned to the computer and are stored in the memory M. The memory M is shown in FIG. 2 as a simple shift register in which data inputted at the right-hand side of the memory M in FIG. 2 is moved to the left each time that a period of time Δt has expired. Other types of memory may be used as well. The memory M comprises, for example, n+2 memory locations, rumbered from zero to n+1 in FIG. 2. In the memory M data is stored on a first-in first-out basis. Each time that a period of time At has elapsed all data in the memory M is shifted one place from right to left, and data in the memory space n+1 is either discarded or used by the computer 20 depending on a signal CI. At the same instant the memory location zero is filled with actual pointer coordinates of a mouse 10. Thereafter, everything remains the same until another period of time Δt has elapsed, upon which the operation described hereinbefore is repeated. In this way, there are always n+1 pointer coordinates available for use by the computer 20.

In a first embodiment of the invention, for which reference is made to FIG. 2, at an instant t₀ (see FIGS. 1A, 1B and 1C) the memory M has all its memory locations 0, 1 . . . , n, n+1 filled with pointer coordinates that were actual at instants t₀, t₀-Δt . . . t₀-n.Δt and t₀-δt. Referring now to FIGS. 1A and 1C, it will be appreciated that at the instant t₀-δt the mouse button has not yet been touched by the user, but the pointer coordinates are already the coordinates that the user wanted to be assigned to the computer. Now, the generation of the signal CI at the instant to as shown in FIG. 1B is used as an input to the computer 20 to trigger the computer to take the contents of memory location n+1 as the pointer coordinates assigned to it. Since the memory location n+1 stres pointer coordinates, that were actual at the instant t₀-δt, the pointer coordinates assigned to the computer fully and accurately coincide with the pointer coordinates that the user had in mind as pointer coordinates to be assigned to the computer.

FIG. 3 shows another embodiment of a computer connectable to a mouse according to the invention. In the embodiment described above with reference to FIG. 2 it is assumed that the memory location n+1 indeed contains pointer coordinates that do not deviate from the pointer coordinates of the desired screen position. However, already after reaching the desired screen position at the instant t₂ it cannot be prevented that erratic movements of the mouse take place, as a result of which, for example at the instant t₀-δt, incorrect, i.e. undesired, pointer coordinates are present. In order to prevent or minimize consequences of erratic behavior between the instants t₂ and t₀-δt, an averaging function, shown schematically as 30 in FIG. 3, is applied to the contents of a number of storage locations of the memory M. In FIG. 3 the averaging function is applied to the contents of memory locations i, i+1, . . ., n−1, n and n+1.

Various variants of an embodiment as illustrated in FIG. 3 are possible.

For example, the contents of all the memory locations 0 through n+1 could be used in the averaging function 30.

It is also possible to first continue inputting actual pointer coordinates into memory M for a predetermined period of time or for a predetermined number of computer clock cycles before applying the averaging function 30 as shown in FIG. 4. One may appreciate that in the embodiment illustrated in FIG. 4 the actual pointer coordinates at the instant to are in a memory location i.

Though the function 30 has been described as an averaging function hereinbefore, it is to be noted that various kinds of averaging which are known per se can be applied to the pointer coordinates that the function 30 uses as an input to calculate its output to the computer 20. The function 30 may be operational all the time, or it may be triggered only for a one-time calculation each time that a mouse button is pressed, for example in response to the signal CI.

The function 30 may be present in hardware or in software or in embedded software. When the function 30 is present in software certain parameters may, for example, be set to accommodate certain movement specifics of the user. The function 30 may also be a self-learning program, for example incorporating a neural network.

Hereinabove, it has been described that the memory, the means for storing pointer coordinates in the memory, and the means for assigning pointer coordinates to the computer upon clicking of a mouse button are all present in the computer. However, some of those means or parts thereof may be present in the mouse. The same holds for the function 30, which may be present in the computer, or in the mouse, or it may be shared by them.

1. An information processing device connectable to a displacement signal generating device, characterized in that a memory is present, in that means are present for storing pointer coordinates in the memory on a first-in first-out basis, and in that means are present for, upon clicking of the displacement signal generating device button, assigning to the information processing device pointer coordinates as a function of pointer coordinates present in the memory.

2. An information processing device according to claim 1, characterized in that the function enables pointer coordinates that have been present in the memory for the longest period of time to be assigned to the information processing device.

3. An information processing device according to claim 1, characterized in that the function enables pointer coordinates to be assigned to the information processing device, which pointer coordinates are an average of certain pointer coordinates inputted into the memory during a first predetermined period of time before clicking and during a second predetermined period of time after clicking.

4. An information processing device according to claim 1, characterized in that the function enables pointer coordinates to be assigned to the information processing device, which ponter coordinates are an average of certain pointer coordinates inputted into the memory during a first number of information processing device clock cycles before clicking and during a second predetermined number of information processing device clock cycles after clicking.

5. An information processing device according to claim 3 or 4, characterized in that the second period of time and the second predetermined number of information processing device clock cycles, respectively, are zero, and in that the function enables pointer coordinates that are an average of certain pointer coordinates present in the memory at the instant of clicking to be assigned to the information processing device.

6. An information processing device according to claim 5, characterized in that the certain pointer coordinates present in the memory at the instant of clicking are all pointer coordinates present in the memory at the instant of clicking.

7. An information processing device according to any one of claims 1 through 6, characterized in that the means for assigning comprise a computer program.

8. A displacement signal generating device connectable to an information processing device according to any one of claims 1 through 7, characterized in that at least the memory, or the storing means, or the means for assigning, are at least partly present in the displacement signal generating device.
